(19) United States
(12) Patent Application Publication
(10) Pub. No.: US 2023/0252387 A1
(43) Pub. Date: Aug. 10, 2023

(54) APPARATUS, METHOD AND RECORDING MEDIUM STORING COMMANDS FOR PROVIDING ARTIFICIAL-INTELLIGENCE-BASED RISK MANAGEMENT SOLUTION IN CREDIT EXPOSURE BUSINESS OF FINANCIAL INSTITUTION

(71) Applicant: Dofiang Corp., Seoul (KR)

(72) Inventors: Kyoung Hong PARK, Gyeonggi-do (KR); Bo Reum CHO, Seoul (KR)

(73) Assignee: Dofiang Corp., Seoul (KR)

(21) Appl. No.: 18/163,031

(22) Filed: Feb. 1, 2023

(30) Foreign Application Priority Data
Feb. 4, 2022 (KR) 10-2022-0014792

(51) Int. Cl. G06Q 10/0635; G06Q 10/0637

(52) U.S. Cl. CPC G06Q 10/0635; G06Q 10/0637

(57) ABSTRACT

An aspect of the present disclosure may provide an apparatus for assessing a risk of a company’s stock as collateral. The apparatus according to the present disclosure may include at least one processor configured to: determine, based on a financial statement of the company, data relating to a first attribute group including at least one attribute relating to the company’s financial statement, input the data relating to the first attribute group into the first artificial neural network, determine, based on an output of the first artificial neural network, a first risk value indicating a degree of risk of a financial status of the company, and determine a final risk value of stocks of the company as collateral, based on the first risk value.

### CROSS-REFERENCE TO RELATED APPLICATION

This application is based upon and claims the benefit of priority from Korean Patent Application No. 10-2022-0014792, filed on Feb. 4, 2022, the entire contents of which are incorporated herein by reference.

### TECHNICAL FIELD

The present disclosure relates to a technology for assessing the risk of a company’s stock as collateral, based on artificial intelligence technology.

### BACKGROUND

In the existing credit exposure business of financial institutions, a method for assessing the risk of a company’s stock as collateral has been manually performed according to a so-called heuristic manner. However, this method is problematic in that there may be errors in a decision-making process because people directly make decisions, and that risks cannot be consistently assessed and managed due to individual differences. Accordingly, the demand for more systematically and accurately assessing the risk of collateral stock has been increasing in the industry.

### SUMMARY

The present disclosure provides a technique for assessing the risk of a company’s stock as collateral, based on artificial intelligence technology.

An aspect of the present disclosure may provide an apparatus for assessing the risk of a company’s stock as collateral. The apparatus according to the present disclosure may include: at least one processor; and at least one memory configured to store instructions, which cause the at least one processor to perform computation when executed by the at least one processor, and a first artificial neural network trained to analyze financial statement, wherein according to the instructions, the at least one processor is configured to: determine, based on a company’s financial statement, data about a first attribute group including at least one attribute about the company’s financial statement, input the data about the first attribute group into the first artificial neural network, determine, based on an output of the first artificial neural network, a first risk value indicating a degree of risk of the company’s financial status, and determine a final risk value of the company’s stock as collateral, based on the first risk value.

In an embodiment, the at least one attribute included in the first attribute group may be an attribute which has a value derived based on raw data included in a period of a predetermined length, among multiple pieces of raw data included in the company’s financial statement.

In an embodiment, the first artificial neural network may be trained to, based on a learning data set including data relating to multiple first attribute groups and labeled as risky or not, classify each piece of learning data included in the learning data set.

In an embodiment, the at least one memory may further store a second artificial neural network trained to analyze stock trades, and wherein the at least one processor may determine, based on information about stock trades of the company, data about a second attribute group including at least one attribute about stock price volatility of the company, may input the data about the second attribute group into the second artificial neural network, may determine, based on an output of the second artificial neural network, a second risk value indicating a degree of risk of the stock price volatility of the company, and may determine the final risk value based on the first risk value and the second risk value.

In an embodiment, the at least one attribute included in the second attribute group may be an attribute which has a value derived based on raw data included in a period of a predetermined length among multiple pieces of raw data about the stock trades of the company.

In an embodiment, the at least one attribute determined based on the raw data included in the period of the predetermined length may be determined based on a rolling window technique.

In an embodiment, the second artificial neural network may include at least one weight, wherein the at least one processor may determine the at least one weight based on a learning data set, which includes data relating to multiple second attribute groups and labeled as risky or not, and an error back propagation algorithm about the learning data set, and wherein the at least one weight may be determined such that an error calculated based on an output value of the second artificial neural network and a label value of the learning data set is minimized.

In an embodiment, the at least one memory may further store a third artificial neural network trained to analyze a corporate bond, and wherein the at least one processor may determine, based on information about a bond issued by the company, data about a third attribute group including at least one attribute about the company’s bond, may input the data about the third attribute group into the third artificial neural network, may determine, based on an output of the third artificial neural network, a third risk value indicating a degree of risk of the company’s bond, and may determine the final risk value based on the first risk value and the third risk value.

In an embodiment, the third artificial neural network may be trained to, when the data relating to the third attribute group determined for each of bonds of different companies having an identical rating is input, determine the third risk value for each bond, based on the volatility of closing prices of the bonds issued by the companies compared with that of a previous day.

In an embodiment, the at least one memory may further store a fourth artificial neural network trained to analyze non-numerical unstructured data, and wherein the at least one processor may determine, based on non-numerical unstructured data of the company, data about a fourth attribute group including at least one attribute about the company, may input the data about the fourth attribute group into the fourth artificial neural network, may determine, based on an output of the fourth artificial neural network, a fourth risk value indicating a degree of risk of the company based on the non-numerical unstructured data of the company, and may determine the final risk value based on the first risk value and the fourth risk value.

In an embodiment, the non-numerical unstructured data of the company may include notes to the company’s financial statement, news data about the company, and social network service (SNS) data about the company.

In an embodiment, the fourth artificial neural network may include a (4-1)th sub artificial neural network for emotion analysis on non-numerical unstructured data; and a (4-2)th sub-artificial neural network for category analysis on non-numerical unstructured data.

In an embodiment, the at least one processor may determine the fourth risk value by performing a weighted sum of an output value of the (4-1)th sub artificial neural network and an output value of the (4-2)th sub artificial neural network.

In an embodiment, the at least one memory may further store a second artificial neural network trained to analyze stock trades, a third artificial neural network trained to analyze a corporate bond, and a fourth artificial neural network trained to analyze non-numerical unstructured data. The at least one processor may determine, based on information about stock trades of the company, data about a second attribute group including at least one attribute about stock price volatility of the company, may input the data about the second attribute group into the second artificial neural network, may determine, based on an output of the second artificial neural network, a second risk value indicating a degree of risk of the stock price volatility of the company, may determine, based on information about a bond issued by the company, data about a third attribute group including at least one attribute about the company’s bond, may input the data about the third attribute group into the third artificial neural network, may determine, based on an output of the third artificial neural network, a third risk value indicating a degree of risk of the company’s bond, may determine, based on non-numerical unstructured data of the company, data about a fourth attribute group including at least one attribute about the company, may input the data about the fourth attribute group into the fourth artificial neural network, may determine, based on an output of the fourth artificial neural network, a fourth risk value indicating a degree of risk of the company based on the non-numerical unstructured data of the company, and may determine the final risk value based on the first risk value, the second risk value, the third risk value, and the fourth risk value.

Another aspect of the present disclosure may provide a method for assessing the risk of a company’s stock as collateral. The method according to the present disclosure may be a method performed in a computer including at least one processor and at least one memory configured to store instructions to be executed by the at least one processor, wherein the at least one memory is configured to store instructions, which cause the at least one processor to perform calculation, and a first artificial neural network trained to analyze financial statement. The method may be performed by the at least one processor according to the instructions and may include: determining, based on a company’s financial statement, data about a first attribute group including at least one attribute about the company’s financial statement; inputting the data about the first attribute group into the first artificial neural network; determining, based on an output of the first artificial neural network, a first risk value indicating a degree of risk of the company’s financial status; and determining a final risk value of the company’s stock as collateral, based on the first risk value.

In an embodiment, the at least one memory may further store a second artificial neural network trained to analyze stock trades, and the method may be performed by the at least one processor and may further include: determining, based on information about stock trades of the company, data about a second attribute group including at least one attribute about stock price volatility of the company; inputting the data about the second attribute group into the second artificial neural network; determining, based on an output of the second artificial neural network, a second risk value indicating a degree of risk of the stock price volatility of the company; and determining the final risk value based on the first risk value and the second risk value.

In an embodiment, the at least one memory may further store a third artificial neural network trained to analyze a corporate bond, and the method may further include performing, by at least one processor: determining, based on information about a bond issued by the company, data about a third attribute group including at least one attribute about the company’s bond; inputting the data about the third attribute group into the third artificial neural network; determining a third risk value about the company’s bond, based on an output of the third artificial neural network; and determining the final risk value based on the first risk value and the third risk value.

In an embodiment, the at least one memory may further store a fourth artificial neural network trained to analyze non-numerical unstructured data, and the method may be performed by the at least one processor and may further include: determining, based on non-numerical unstructured data of the company, data about a fourth attribute group including at least one attribute about the company; inputting the data about the fourth attribute group into the fourth artificial neural network; determining, based on an output of the fourth artificial neural network, a fourth risk value indicating a degree of risk of the company based on the non-numerical unstructured data of the company; and determining the final risk value based on the first risk value and the fourth risk value.

In an embodiment, the at least one memory may further store a second artificial neural network trained to analyze stock trades, a third artificial neural network trained to analyze a corporate bond, and a fourth artificial neural network trained to analyze non-numerical unstructured data, and the method may be performed by the at least one processor and may further include: determining, based on information about stock trades of the company, data about a second attribute group including at least one attribute about stock price volatility of the company; inputting the data about the second attribute group into the second artificial neural network; determining, based on an output of the second artificial neural network, a second risk value indicating a degree of risk of the stock price volatility of the company; determining, based on information about a bond issued by the company, data about a third attribute group including at least one attribute about the company’s bond; inputting the data about the third attribute group into the third artificial neural network; determining a third risk value about the company’s bond, based on an output of the third artificial neural network; determining, based on non-numerical unstructured data of the company, data about a fourth attribute group including at least one attribute about the company; inputting the data about the fourth attribute group into the fourth artificial neural network; determining, based on an output of the fourth artificial neural network, a fourth risk value indicating a degree of risk of the company based on the non-numerical unstructured data of the company; and determining the final risk value based on the first risk value, the second risk value, the third risk value, and the fourth risk value.

Another aspect of the present disclosure may provide a non-transitory computer-readable recording medium storing instructions to be executed in a computer in order to assess the risk of a company’s stock as collateral. In the recording medium according to the present disclosure, at least one memory may store instructions which cause at least one processor to perform computation, and a first artificial neural network trained to analyze financial statement, wherein the instructions, when executed by the at least one processor, cause the at least one processor to determine, based on a company’s financial statement, data about a first attribute group including at least one attribute about the company’s financial statement, input the data about the first attribute group into the first artificial neural network, determine, based on an output of the first artificial neural network, a first risk value indicating a degree of risk of the company’s financial status, and determine a final risk value of the company’s stock as collateral, based on the first risk value.

### BRIEF DESCRIPTION OF DRAWINGS

The accompanying drawings, which are incorporated in and constitute a part of the specification, illustrate embodiments of the present disclosure.

FIG. 1 is a block diagram of a computing device according to an embodiment of the present disclosure.

FIG. 2 is a conceptual diagram illustrating a process in which a computing device according to an embodiment of the present disclosure determines a first risk value based on an output of a first artificial neural network.

FIG. 3 is a conceptual diagram illustrating a rolling window technique according to an embodiment of the present disclosure.

FIG. 4 is an exemplary diagram schematically illustrating learning data of a first artificial neural network.

FIG. 5 is a conceptual diagram illustrating a process in which a computing device according to an embodiment of the present disclosure determines a second risk value based on an output of a second artificial neural network.

FIG. 6 is a conceptual diagram illustrating a process in which a computing device according to an embodiment of the present disclosure determines a third risk value based on an output of a third artificial neural network.

FIG. 7 is a conceptual diagram illustrating a process in which a computing device according to an embodiment of the present disclosure determines a fourth risk value based on an output of a fourth artificial neural network.

FIG. 8 is a flowchart of operations of a computing device according to an embodiment of the present disclosure.

### DETAILED DESCRIPTION

Various embodiments described herein are exemplified for the purpose of clearly explaining the technical idea of the present disclosure, and are not intended to limit the present disclosure to specific embodiments. The technical idea of the present disclosure includes various modifications, equivalents, and alternatives of each embodiment described herein, and embodiments selectively combined from all or a part of each embodiment. In addition, the scope of the technical idea of the present disclosure is not limited to various embodiments presented below or detailed description thereof.

All terms used herein, including technical or scientific terms, have meanings that are generally understood by those skilled in the art to which the present disclosure pertains, unless otherwise specified.

Expressions used herein, such as “include,” “may include,” “provided with,” “may be provided with,” “have,” “may have,” etc., imply that target features (e.g., a function, an operation, or an element) exist, and do not exclude the existence of other additional features. That is, such expressions should be understood as open-ended terms connoting the possibility of inclusion of other embodiments.

A singular expression used herein may include meanings of plurality, unless otherwise mentioned in the context, and this also applies to a singular expression recited in the claims.

The expressions “a first,” “a second,” “first,” or “second” used herein are used to distinguish one object from another object in referring to a plurality of homogeneous objects, unless the context dictates otherwise, and do not limit the order or the importance between the objects. In an embodiment, multiple types of attribute groups according to the present disclosure may be distinguished from each other by being expressed as a “first attribute group,” a “second attribute group,” and the like. In an embodiment, multiple types of artificial neural networks according to the present disclosure may be distinguished from each other by being expressed as a “first artificial neural network,” a “second artificial neural network,” and the like. In an embodiment, multiple types of risk values according to the present disclosure may be distinguished from each other by being expressed as a “first risk value,” a “second risk value,” and the like.

In the present disclosure, the “artificial neural network” may refer to a data set for generating predetermined output data with respect to input data. In this case, the artificial neural network may include a weight or a bias value for at least one node. For example, an artificial neural network may be a “numerical model,” and in this case, the artificial neural network may include a weight, etc. used in algorithms or mathematical expressions.

Expressions such as “A, B, and C,” “A, B, or C,” “A, B, and/or C,” “at least one of A, B, and C,” “at least one of A, B, or C,” and “at least one of A, B, and/or C,” used herein may imply each listed item or all possible combinations of listed items. For example, “at least one of A or B” may refer to all of (1) at least one A, (2) at least one B, and (3) at least one A and at least one B.

The expression “unit” used herein may imply software or hardware component such as a field-programmable gate array (FPGA) or an application specific integrated circuit (ASIC). However, the “unit” is not limited to hardware and software. The “unit” may be configured to be stored in an addressable storage medium or configured to execute one or more processors. In an embodiment, the “unit” may include elements such as software elements, object-oriented software elements, class elements, task elements, a processor, a function, a procedure, a subroutine, segments of a program code, a driver, firmware, a microcode, a circuit, data, a database, a data structure, a table, an array, and a parameter.

The expression “based on” used herein is used to describe one or more factors that influence a decision, an action of judgment, or an operation described in a phrase or sentence including the relevant expression, and this expression does not exclude an additional factor influencing the decision, the action of judgment, or the operation.

Herein, when an element (e.g., a first element) is expressed as being “coupled” or “connected” to another element (a second element), the element may be coupled or connected directly to the other element, or may be coupled or connected to the other element via another new element (e.g., a third element).

The expression “configured to” used in the present disclosure may imply “designed to,” “having the capacity to,” “adapted to,” “made to,” “capable of,” etc. according to the context. This expression is not limited to implying “specifically designed to” in hardware. For example, a processor configured to perform a specific operation may imply a special-purpose computer structured through programming to perform the specific operation.

In the present disclosure, artificial intelligence (AI) may refer to a technology that imitates human learning ability, reasoning ability, perception ability, etc., and implements the same with a computer. Artificial intelligence may include machine learning or element technology using the machine learning. The machine learning may refer to an algorithm that extracts at least one feature of learning data in order to classify input data. In addition, technologies that mimic functions of the human brain, such as cognition and determination, by using a machine learning algorithm, may also be understood as the category of artificial intelligence. For example, technical fields such as linguistic understanding, visual understanding, inference/prediction, knowledge expression, and operation control may be included.

In the present disclosure, an artificial neural network may be designed to implement a human brain structure in a computer, and may include multiple network nodes that simulate neurons of a human neural network and have weights. The multiple network nodes may have a connection relationship therebetween by simulating synaptic activities of neurons that transmit and receive signals through synapses. In an artificial neural network, the network nodes may exchange data therebetween according to a convolutional connection relationship while being positioned in layers having different depths. The artificial neural network may be, for example, a convolutional neural network model, or the like. In the present disclosure, the artificial neural network may be a model trained according to a predetermined machine learning method, and may imply a model in which a weight for at least one network node, included in a non-learned model, is determined by machine learning. The machine learning may refer to improving computer software’s ability to process data, through learning using data and data processing experience. The artificial neural network is built by modeling correlations between data, and the correlations may be expressed by multiple parameters. The artificial neural network may extract and analyze features from given data to derive correlations between data, and optimizing the parameters of the artificial neural network by repeating this process may be referred to as machine learning. For example, an artificial neural network may learn mapping (correlation) between an input and an output with respect to data given as an input/output pair. Alternatively, even when only input data is given, the artificial neural network may learn the relationship between given data by deriving regularity between the given data. In the present disclosure, the term “artificial neural network” may be used interchangeably with the term “artificial neural network model.”

Hereinafter, various embodiments of the present disclosure will be described with reference to the accompanying drawings. In the accompanying drawings and the description of the drawings, identical or substantially equivalent elements may be assigned with identical reference numerals. Furthermore, in the following description of various embodiments, redundant descriptions of the identical or relevant elements will be omitted. However, this does not imply that such elements are not included in the embodiments.

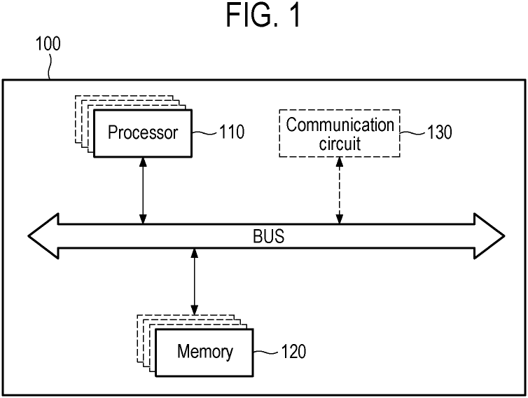

FIG. 1 is a block diagram of a computing device 100 according to an embodiment of the present disclosure. The computing device 100 of the present disclosure may determine a risk value of a company’s stock as collateral, based on at least one artificial neural network. The computing device 100 may ensemble output values of multiple artificial neural networks to determine a risk value of a company’s stock as collateral. That is, the computing device 100 may determine a final risk value of the company’s stock as collateral, based on the output values of the multiple artificial neural networks.

The computing device 100 according to an embodiment of the present disclosure may generate, based on a company’s financial statement, input data (i.e., data about a first attribute group) to be input into a first artificial neural network. The computing device 100 may input the data about the first attribute group to the first artificial neural network, and may determine, based on an output of the first artificial neural network, a first risk value indicating a degree of risk of the company’s financial status.

The computing device 100 according to an embodiment of the present disclosure may generate, based on information about stock trades of the company, input data (i.e., data about a second attribute group) to be input into a second artificial neural network. The computing device 100 may input the data about the second attribute group into the second artificial neural network, and may determine, based on an output of the second artificial neural network, a second risk value indicating a degree of risk of stock price volatility of the company.

The computing device 100 according to an embodiment of the present disclosure may generate, based on information on a bond issued by the company, input data (i.e., data about a third attribute group) to be input into a third artificial neural network. The computing device 100 may input the data about the third attribute group into the third artificial neural network, and may determine, based on an output of the third artificial neural network, a third risk value indicating a degree of risk of the company’s bond.

The computing device 100 according to an embodiment of the present disclosure may generate, based on unstructured data about the company, input data (i.e., data about a fourth attribute group) to be input into a fourth artificial neural network. The computing device 100 may input the data about the fourth attribute group into the fourth artificial neural network, and may determine, based on an output of the fourth artificial neural network, a fourth risk value indicating a degree of risk based on the unstructured data of the company.

The computing device 100 according to an embodiment of the present disclosure may determine a final risk value based on at least one of the above-described first to fourth risk values. For example, the computing device 100 may determine the final risk value by calculating a weighted average of the first to fourth risk values.

According to an embodiment of the present disclosure, the computing device 100 may include at least one processor 110 and/or at least one memory 120 as elements. In some embodiments, at least one of these elements of the computing device 100 may be omitted, or other elements may be added to the computing device 100. In some embodiments, additionally or alternatively, some elements may be integrated and implemented, or may be implemented as a single entity or multiple entities. In the present disclosure, the at least one processor 110 may be referred to as “processor 110.” The expression “processor 110” may imply a set of one or more processors, unless the context clearly dictates otherwise. In the present disclosure, the at least one memory 120 may be referred to as “memory 120.” The expression “memory 120” may mean a set of one or more memories, unless the context clearly dictates otherwise.

At least some of the internal and external elements of the computing device 100 may be connected to each other through a bus, general purpose input/output (GPIO), a serial peripheral interface (SPI), or a mobile industry processor interface (MIPI), and may exchange data and/or signals with each other.

The processor 110 may drive software (e.g., an instruction, a program, etc.) to control at least one element of the computing device 100 connected to the processor 110. In addition, the processor 110 may perform operations such as various calculations, processing, data generation, and processing related to the present disclosure. Also, the processor 110 may load data, etc. from or in the memory 120, or may store data, etc. in the memory 120.

The memory 120 may store various types of data. The data stored in the memory 120 may be data obtained, processed, or used by at least one element of the computing device 100, and may include software (e.g., an instruction, a program, etc.). The memory 120 may include volatile and/or non-volatile memory. In the present disclosure, the instruction or the program may be software stored in the memory 120, and may include an operating system for controlling resources of the computing device 100, an application, and/or middleware for providing various functions to the application so that the application can use the resources of the computing device 100. In an embodiment, the memory 120 may store instructions which, when executed by the processor 110, cause the processor 110 to perform calculation. In an embodiment, the memory 120 may include at least one artificial neural network.

In an embodiment, the computing device 100 may further include a communication circuit 130. The communication circuit 130 may perform wireless or wired communication between the computing device 100 and a server or between the computing device 100 and other devices. For example, the communication circuit 130 may perform wireless communication according to a scheme such as enhanced Mobile Broadband (eMBB), Ultra Reliable Low-Latency Communications (URLLC), Massive Machine Type Communications (MMTC), Long-Term Evolution (LTE), LTE Advance (LTE-A), New Radio (NR), Universal Mobile Telecommunications System (UMTS), Global System for Mobile communications (GSM), Code Division Multiple Access (CDMA), Wideband CDMA (WCDMA), Wireless Broadband (WiBro), Wireless Fidelity (WiFi), Bluetooth, Near-Field Communication (NFC), Global Positioning System (GPS), or Global Navigation Satellite System (GNSS). For example, the communication circuit 130 may perform wired communication according to a scheme such as a Universal Serial Bus (USB), a High-Definition Multimedia Interface (HDMI), Recommended Standard-232 (RS-232), or Plain Old Telephone Service (POTS). In an embodiment, the communication circuit 130 may communicate with other devices.

The computing device 100 according to various embodiments of the present disclosure may be various types of devices. For example, a computing device may be a portable communication device, a portable multimedia device, a wearable device, a home appliance, or a device resulting from a combination of one or more of the foregoing devices. The computing device of the present disclosure is not limited to the above-described devices.

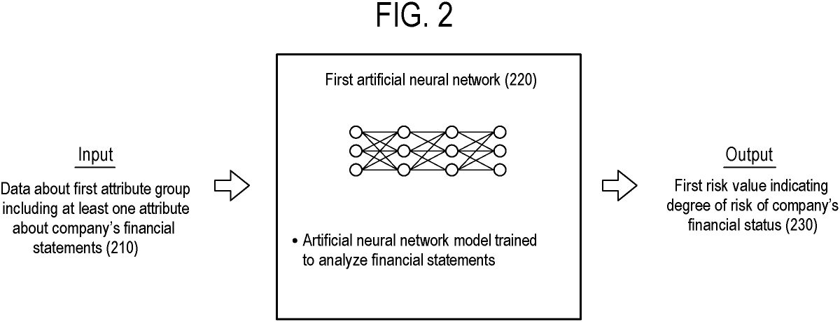

FIG. 2 is a conceptual diagram illustrating a process in which the computing device 100 according to an embodiment of the present disclosure determines a first risk value based on an output of a first artificial neural network. Hereinafter, the process of determining the first risk value by the computing device 100 will be described below with reference to FIG. 2. The memory 120 according to the present disclosure may store a first artificial neural network 220 trained to analyze financial statement.

The processor 110 may determine, based on a company’s financial statement, data about a first attribute group including at least one attribute about the company’s financial statement. In the present disclosure, the data about the first attribute group may be referred to as “first attribute group data” for convenience. In the present disclosure, the financial statement refers to documents showing the financial status or management performance of the company. For example, financial statement may include information about a company’s assets, liabilities, equity, income, expenses, etc. In the present disclosure, the term “attribute” may be used as a unit for referring to each item of input data that is input into an artificial neural network. In the present disclosure, the term “attribute” may be used interchangeably with the term “feature.” In the present disclosure, an “attribute group” may include at least one “attribute.” In the present disclosure, the attribute group may be a set of items included in input data that is input into an artificial neural network.

In an embodiment of the present disclosure, the first attribute group may include each account title included in the financial statement as an attribute. For example, the first attribute group may include, as an attribute, at least one among cash, accounts receivable, commodities, land, buildings, patents, development costs, deposits, short-term borrowings, accounts payable, unearned revenue, debentures, capital, earned surplus reserve, stock options, etc. The data about the first attribute group may include raw data described in financial statement. The data about the first attribute group may be a value derived according to a predetermined algorithm from a value of each attribute described in the financial statement. At this time, the algorithm for deriving the value may be defined as a specific mathematical expression. For example, one attribute included in the first attribute group may be a “capital impairment rate.” The capital impairment rate may be calculated based on Mathematical Expression 1 below.

$$\text{Capital} \text{inpairment} \text{rate} = \frac{\left(\text{issued} \text{capital} - \text{total} \text{equity}\right)}{\text{issued} \text{capital}}$$

The processor 110 may obtain a value of an individual attribute included on the left side of Mathematical Expression 1 from the company’s financial statement. The processor 110 may include “capital impairment rate” as one attribute of the first attribute group, so that when determining a risk value based on the output of the artificial neural network, the processor 110 determines the risk value reflecting the risk of the company being incorporated into administrative issues or the risk of the company being delisted.

In an embodiment of the present disclosure, at least one attribute included in the first attribute group may be an attribute which has a value derived based on raw data included in a period of a predetermined length, among multiple pieces of raw data included in the company’s financial statement. The raw data included in the period of the predetermined length may be data obtained from financial statement disclosed at multiple different time points. The raw data included in the period of the predetermined length may include multiple pieces of data. At this time, the period of the predetermined length may be, for example, 3 months, 6 months, 12 months, 4 years, etc. Hereinafter, for convenience of description, an attribute determined based on the raw data included in the period of the predetermined length, among the attributes included in the first attribute group, may be referred to as an “attribute P.” Multiple attributes P may exist, and may be respectively referred to as an attribute P-1, an attribute P-2, etc. for distinction. The processor 110 may calculate a value of the attribute P based on multiple pieces of raw data included in the company’s financial statement. The attribute P according to an embodiment of the present disclosure may be an average, weighted average, variance, or standard deviation of the raw data included in the period of the predetermined length. For example, the attribute P may be “an average of sales in the previous 4 quarters.” For example, the attribute P may be “variance of net income over the previous 10 years.” For example, the attribute P may be an “operating loss in the last 4 business years.” The above examples of the attribute P are only a description for explanation and does not limit the present disclosure, and as described above, the processor 110 may define an attribute to be included in the first attribute group based on raw data included in a period of a predetermined length, thereby setting an attribute representing a tendency of past data as input data of the first artificial neural network. As a result, the processor 110 may accurately determine the first risk value.

In an embodiment according to the present disclosure, the processor 110 may determine, based on feature engineering, at least one attribute included in the first attribute group. The feature engineering refers to a technique for determining an optimal attribute (or feature) as an input into the processor 110 when the processor 110 determines a predetermined risk value as an output. The processor 110 may receive the attribute determined based on the feature engineering, and may calculate an output value based on an artificial neural network. The feature engineering may include a rolling window technique.

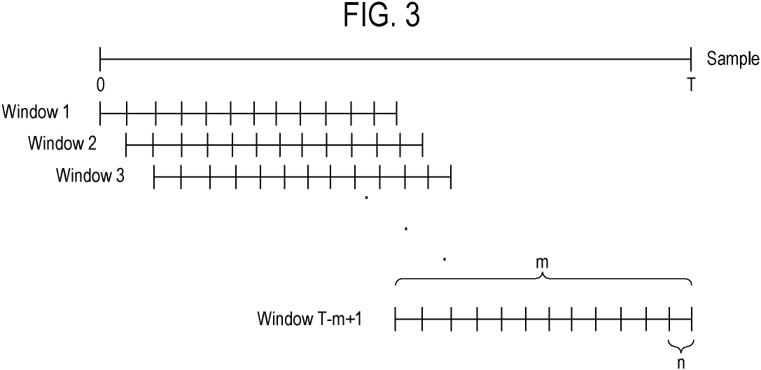

FIG. 3 is a conceptual diagram illustrating a rolling window technique according to an embodiment of the present disclosure. In the present disclosure, the rolling window technique is a technique for verifying the accuracy or stability of a specific attribute over the entire time series data. An attribute to be verified by the rolling window technique may be an attribute defined by a predetermined numerical model or algorithm. That is, the processor 110 may divide the entire time series data into multiple pieces of sub time series data and may determine, based on calculation for each sub data, at least one attribute included in the first attribute group. In this case, the time-series data refers to data, in which multiple pieces of data are arranged in chronological order and which has meaning in order. The entire time series data for performing a rolling window may be raw data included in past financial statement.

In order to verify the specific attribute by using the rolling window technique, the processor 110 may divide the entire time series data into multiple pieces of sub time series data and then perform unit calculation based on each piece of sub time series data. The sub time series data may be distinguished by a temporal range referred to as a “window.” In FIG. 3, the total length of time series data is referred to as T (T is a natural number greater than or equal to 1), and the size of a window is referred to as m (m≤T). The size of a window becomes the size of one piece of sub-time-series data when the entire time-series data is divided into multiple pieces of sub time-series data through the window. Also, the size of the window determines the number of pieces of data used in each unit calculation by the processor 110. That is, the fact that the size of a window is m implies that the number of pieces of data referred to in each unit calculation for verifying a specific attribute is m. The processor 110 may predict a predetermined number of pieces of data by performing unit calculation based on each window. For example, when the size of a window is m, the number of pieces of data to be predicted may be the last n (n < m). In this case, the processor 110 may predict the last n pieces of following data by referring to m-n pieces of preceding data within the window. Specifically, when n is 1, the processor 110 may predict one following last piece of data by referring to preceding m-1 pieces of data among data of each window. Hereinafter, for convenience of description, a case in which n is 1 will be described. For example, when the length of the entire time series data is T and the size of a window is m (m≤T), the processor 110 may obtain a total of T-m+1 pieces of sub time series data. The processor 110 may determine a predicted value for one last piece of data included in each piece of sub time series data by performing unit calculation on each of the T-m+1 pieces of sub-time-series data. The processor 110 may calculate an error between a true value and the predicted value of the one last piece of data included in each sub-data. The processor 110 may calculate an error of a corresponding attribute by integrating errors calculated as many times as T-m+1. For example, the processor 110 may calculate an error of the corresponding attribute by calculating a root mean square error (RMSE) of T-m+1 errors.

When there are multiple numerical models, as described above with reference to FIG. 3, the processor 110 according to an embodiment of the present disclosure may calculate an error regarding each numerical model and compare the errors regarding the multiple numerical models, thereby determining that a numerical model having the smallest error value, among the multiple numerical models, has the best predictive performance. The processor 110 may determine, based on the rolling window technique, some numerical models, which satisfy a predetermined error reference, among a plurality of numerical models as attributes included in the first attribute group. The processor 110 may determine, based on the rolling window technique, at least one attribute included in the first attribute group. The processor 110 may determine an attribute (i.e., the attribute P) to be included in the first attribute group, based on raw data included in a period of a predetermined length among multiple pieces of raw data included in the financial statement, wherein the attribute may be determined based on the rolling window technique.

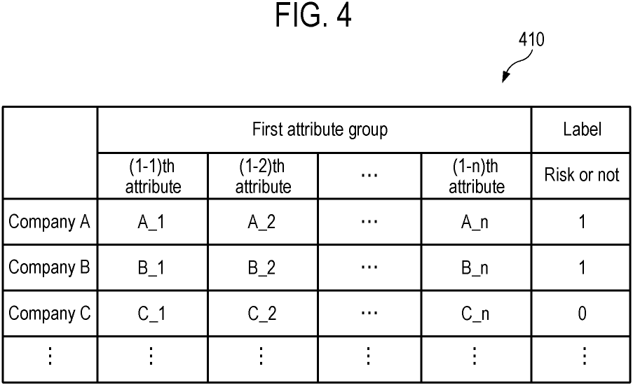

FIG. 4 is an exemplary diagram schematically illustrating learning data of a first artificial neural network 220. A first learning data set 410 may include data 210 about a first attribute group that is calculated for each of multiple companies. The first learning data set 410 may include a label value for the first attribute group data. A label for the first attribute group data may be a value indicating whether a corresponding company’s financial status is at risk. The label may be, for example, a binary value.

In an embodiment of the present disclosure, in a first attribute group data for each of multiple companies, the processor 110 may train the first artificial neural network 220 based on the first learning data set 410 which includes the first attribute group data labeled as whether the corresponding company’s financial status is risky. In the present disclosure, each artificial neural network model or numerical model may be trained through a different external device independent of the computing device 100 and then stored in the memory 120. In this disclosure, for convenience of description, it is assumed that an artificial neural network model or a numerical model is trained by the processor 110 and stored in the memory 120. The processor 110 may train the first artificial neural network 220 by performing a classification task based on the above-described first learning data set 410. The processor 110 may use the first learning data set 410 to train the first artificial neural network 220, based on a proportional hazards model or a survival tree decision-making model. The processor 110 may control or calculate the first artificial neural network 220 so that the first artificial neural network 220 outputs a value (hereinafter referred to as a risk value) on whether there is a risk with respect to individual learning data included in the first learning data set 410. Specifically, the processor 110 may input data about the first attribute group of a company “A” into the first artificial neural network 220 and obtain a risk value by an output according to the corresponding input. Also, with respect to each of other companies (e.g., “B” company, “C” company, etc.), the processor 110 may input data about the first attribute group into the first artificial neural network 220, and may obtain a risk value according to each input. The processor 110 may update at least one node weight included in the first artificial neural network 220 so as to minimize an error between each of multiple risk values obtained from the first artificial neural network 220 and a corresponding label value. The updating of the weight may be based on, for example, a backpropagation technique.

When training of the first artificial neural network 220 according to an embodiment of the present disclosure is completed, the processor 110 may input new input data having a similar form to the individual learning data included in the first learning data set into the first artificial neural network 220, and may predict a risk value (i.e., a first risk value) for the new input data, based on an output according to the input. As a result, the processor 110 may input the data 210 about the first attribute group to the first artificial neural network 220, and may determine, based on an output of the first artificial neural network 220, a first risk value 230 indicating the degree of risk for the company’s financial status.

The processor 110 according to an embodiment of the present disclosure may determine a final risk value of the company’s stock as collateral, based on the first risk value. The processor 110 may use the first risk value as the only consideration factor to determine the final risk value of the company’s stock. The processor 110 may also compare the first risk value with a predetermined threshold value to determine the final risk value. For example, when the first risk value is 0.8 and the predetermined critical risk value is 0.7, the processor 110 may determine the final risk value to be 1 because the first risk value (0.8) exceeds the predetermined threshold risk value (0.7). The processor 110 may determine the final risk value from the first risk value by using multiple predetermined threshold risk values.

In an embodiment, the processor 110 may determine the final risk value of the company’s stock, not only based on the first risk value, but also additionally based on an output of another artificial neural network. An embodiment in which the processor 110 determines the final risk value based additionally on an output of another artificial neural network will be described in detail below.

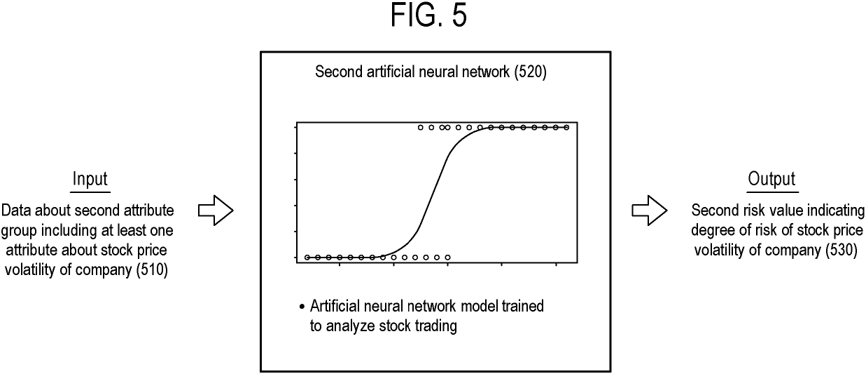

FIG. 5 is a conceptual diagram illustrating a process in which the computing device 100 according to an embodiment of the present disclosure determines a second risk value 530 based on an output of a second artificial neural network 520. In an embodiment, the memory 120 may store the second artificial neural network 520 trained to analyze stock trades. For example, the second artificial neural network may be a regression model based on a sigmoid function. The processor 110 may use the second artificial neural network 520 to determine a second risk value indicating the degree of risk of stock price volatility of a company.

Hereinafter, a process of determining the second risk value 530 by the computing device 100 will be described with reference to FIG. 5. The processor 110 may determine, based on information about stock trades of a company, data 510 about a second attribute group including at least one attribute about stock price volatility of the company. In this disclosure, the data about the second attribute group may be referred to as “second attribute group data” for convenience. For example, information on stock trades of companies listed on the Korean stock market may be obtained from the Korean Exchange. Information on stock trades of a company may include, for example, an opening price, a closing price, a trading volume, a closing price of the previous day, a difference value between closing prices of the current day and the previous day, a ratio of the closing price of the current day to the closing value of the previous day, a maximum price of the previous 5 days, a minimum price of the previous 5 days, and a log value regarding a trading volume, etc. The processor 110 may determine the data 510 about the second attribute group from the information on stock trades of the company. The data on the second attribute group may include raw data included in the information about stock trades. The data about the second attribute group may be a value derived from the information about stock trades according to a predetermined algorithm.

In an embodiment according to the present disclosure, at least one attribute included in the second attribute group may be an attribute which has a value derived based on raw data included in a period of a predetermined length, among multiple pieces of raw data about stock trades of the company. The raw data included in the period of the predetermined length may include multiple pieces of data. The raw data included in the period of the predetermined length may be data obtained from stock trading information obtained at each of different times. The period of the predetermined length may be, for example, 1 millisecond, 1 minute, 1 hour, 1 month, etc. Hereinafter, for convenience of description, an attribute determined based on the raw data included in the period of the predetermined length, among attributes included in the second attribute group, may be referred to as an “attribute Q.” Multiple attributes Q may exist, and may be respectively referred to as an attribute Q-1, an attribute Q-2, etc. for distinction.

The processor 110 may calculate a value for the attribute Q, based on the raw data included in the period of the predetermined length, among multiple pieces of raw data about stock trades of the company. For example, the attribute Q may be an average of daily chart closing prices included in the period of the predetermined length. In this case, the period of the predetermined length may be variously set to 1 second, 1 hour, 1 day, 1 month, 1 year, etc.

In an embodiment according to the present disclosure, the processor 110 may determine the at least one attribute included in the second attribute group, based on a rolling window technique. Since the basic principle of the rolling window technique is the same as that described above in relation to the first attribute group, the differences will be mainly described below. The processor 110 may define, based on the information about stock trades of the company, at least one candidate attribute representing the downward stability of stock price of the company. The at least one candidate attribute may be defined by a predetermined numerical model. For example, a candidate attribute representing the downward stability of stock price of the company may be a mathematical expression that receives a stock price for n days and returns the probability of stock price falling on an (n+1)th day as a value.

In an embodiment of the present disclosure, the processor 110 may determine the second artificial neural network 520, based on a second learning data set including data relating to multiple second attribute groups and labeled as risky or not. The second learning data set may be prepared similarly to the first learning data set 410 described with reference to FIG. 4. In the second learning data set, each label value may be a value indicating whether there is a risk of company stock as collateral according to company stock information. The processor 110 may determine the second artificial neural network 520 by performing learning of a Convolution Neural Network (CNN) model, learning of a Long Short Term Memory (LSTM) model, or a logistic regression task, based on the second training data set. The second artificial neural network according to the present disclosure may be a data set having a CNN model structure. The second artificial neural network according to the present disclosure may be a data set having an LSTM model structure. The second artificial neural network according to the present disclosure may be a data set having a logistic regression model structure. Hereinafter, with reference to Mathematical Expressions 2 and 3, a case in which the second artificial neural network of the present disclosure has a logistic regression model structure will be described as an example.

The logistic regression according to the present disclosure is an analysis task for deriving a function that most accurately predicts output data for each input data in a data pair including “input data (i.e., the second attribute group data) - output data (i.e., label values).” In an example, the second artificial neural network may be a numerical model based on a sigmoid function, and may be expressed as Mathematical Expression 2 below.

$$\text{P} \left(\text{Y} = 1 \left|\text{X} = \vec{x}\right)\right) = \frac{1}{1 + {e}^{- {\vec{β}}^{T} \vec{x}}}$$

In Mathematical Expression 2, x̅ is a symbol representing a value input to the second artificial neural network in a vector form. The vector x̅ may be a vector having the same size as the number of attributes input into the second artificial neural network. The vector β̅ represents a weight vector including weights multiplied by each attribute value of the input vector (x̅). The weight vector (β̅) may have the same dimension as the input vector (x̅). The processor 110 may determine the second artificial neural network by determining the weights included in β̅, based on the second learning data set.

In another example, the second artificial neural network may be a numerical model based on a sigmoid function, and may be expressed as Mathematical Expression 3 below.

$$\text{P} \left(\text{Y} = 1 \left|\text{X} = x\right)\right) = \frac{1}{1 + {e}^{- \left(a x + b\right)}}$$

In Mathematical Expression 3, x is a symbol that simply represents a value input into the second artificial neural network. Parameters a and b may be weights that the processor 110 should determine. The parameter a may be a weight that implies a curve gradient of the second artificial neural network as a sigmoid function. As the parameter a increases, the gradient of an S-curve of the second artificial neural network may increase (that is, the S-curve approaches a stair shape), and as the parameter a decreases, the gradient of the S-curve of the second artificial neural network may decrease (that is, the S-curve approaches a flat shape). The parameter b may be a weight that implies translation of the second artificial neural network as a sigmoid function. The processor 110 may determine the second artificial neural network by determining the parameters a and b of the left side in Mathematical Expression 3, based on the second training data set.

The processor 110 may predict output data from input data, based on the second artificial neural network 520, and may update and/or determine at least one weight included in the second artificial neural network 520 according to the error. The processor 110 may determine at least one weight value of the second artificial neural network 520 based on a learning data set, which includes data relating to multiple second attribute groups and labeled as risky or not, and an error back propagation algorithm. The at least one weight of the second artificial neural network 520 may be determined such that an error calculated based on an output value of the second artificial neural network 520 and a label value of the learning data set is minimized. Specifically, in a learning data set including data relating to multiple second attribute groups and labeled as risky or not, the processor 110 may input random second attribute group data into the second artificial neural network 520 to obtain an output value. The processor 110 may identify a label value of the corresponding second attribute group data from the learning data set and may compare the label value with the obtained output value of the second artificial neural network 520 to calculate an error. The processor 110 may update and/or determine the at least one weight of the second artificial neural network 520 such that the calculated error is minimized. At this time, the processor 110 may square and sum an error for each piece of learning data to calculate the total sum of the errors. The updating of the weight of the second artificial neural network 520 may be iteratively performed for each piece of a predetermined number of learning data according to gradient descent. The process of updating the weight of the second artificial neural network 520 may be referred to as a “learning process” of the second artificial neural network 520.

The processor 110 may train the second artificial neural network 520 such that the difference between a predicted value, which is output by the second artificial neural network 520 in response to input data (i.e., the data on the second attribute group), and a label value of the input data is reduced. Here, training the second artificial neural network 520 such that the difference between the predicted value and the label value is reduced implies that a predicted value (e.g., 0.9, 0.99, etc.) for specific learning data, predicted by the second artificial neural network 520 as an output, becomes equal to a label value (e.g., 1) for the learning data by performing iteration that minimizes the sum of errors As a result, for example, when the label value for the second attribute group data includes 0 and 1, the processor 110 may determine the second artificial neural network 520 to output “1” or a predicted value similar to “1” with respect to new second attribute group data having a pattern similar to that of existing second attribute group data labeled “1.” In addition, the processor 110 may determine the second artificial neural network 520 to output “0” or a predicted value similar to “0” with respect to new second attribute group data having a pattern similar to that of existing second attribute group data labeled “0.”

The processor 110 may input the data 510 about the second attribute group into the second artificial neural network 520, and may determine, based on the output of the second artificial neural network 520, the second risk value 530 indicating the degree of risk of stock price volatility of the company.

As described above, the processor 110 may determine the first risk value 230 based on the output of the first artificial neural network 220. The processor 110 may determine the second risk value 530 based on the output of the second artificial neural network 520. The processor 110 may determine a final risk value of the company’s stock as collateral based on the first risk value 230 and the second risk value 530. The processor 110 may determine the final risk value by assigning a weight to the output of each artificial neural network. For example, the processor 110 may assign a weight of 0.6 to the first risk value and a weight of 0.4 to the second risk value, thereby determining that the final risk value is “0.6 * the first risk value + 0.4 * the second risk value.” The specific numerical values of the weights illustrated here are only examples for description and do not limit the present disclosure.

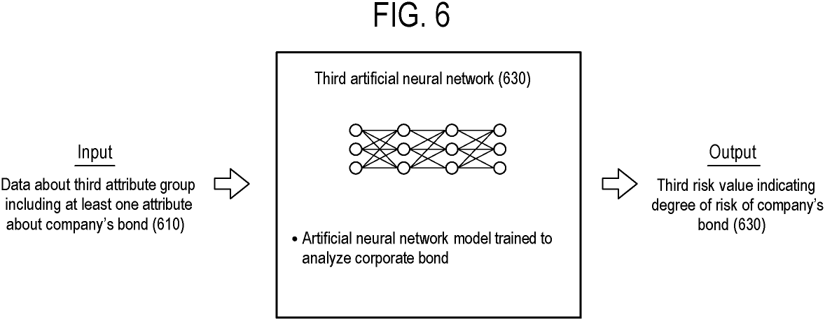

FIG. 6 is a conceptual diagram illustrating a process in which the computing device 100 according to an embodiment of the present disclosure determines a third risk value 630 based on an output of a third artificial neural network 620. In an embodiment, the memory 120 may store the third artificial neural network 620 trained to analyze a corporate bond. The processor 110 may determine, based on the information on a company’s bond, the third risk value 630 indicating a degree of risk of the company’s bond through the third artificial neural network 620.

Specifically, the processor 110 may determine, based on information about a bond issued by a company, data about a third attribute group including at least one attribute about the company’s bond. In the present disclosure, the data related to the third attribute group may be referred to as “third attribute group data” for convenience. The information on the bond issued by the company may include, for example, whether the company has issued a bond, the rating of an issued bond, a change in the rating of a listed bond, a change in a closing price of a listed bond, etc.

The processor 110 may train the third artificial neural network 620, based on a third learning data set including data relating to multiple third attribute groups and labeled as being a junk bond or not. The third learning data set may be prepared in a form similar to that of the first learning data set 410 described with reference to FIG. 4. The junk bond refers to a company’s bond with a high risk of principal loss if invested in the company’s bond due to business deterioration or poor performance of the company. In the third learning data set, the third attribute group data of each company may be labeled as being a junk bond or not. For example, in the third learning data set, an issued bond having a rating of BB (double B) or lower may be labeled as a junk bond. In addition, in a case where the rating of an issued bond exceeds BB (double B) in the third learning data set but the rating of the listed bond decreases by 2 steps or more per predetermined unit period, the bond of the company may be labeled as a junk bond. The processor 110 may train the third artificial neural network 620 by using the third training data set to classify input data as being a junk bond or not. In an embodiment of the present disclosure, when data on a third attribute group determined for each of bonds of different companies having the same rating is input into the third artificial neural network 620, the processor 110 may train the third artificial neural network 620 such that the third artificial neural network 620 determines a third risk value of each bond based on the closing price volatility of the bonds issued by the companies compared with the previous day. For example, in the data on the third attribute group, even when a “bond grade” attribute of bonds of companies A and B is the same good level at which the bonds are not classified as junk bonds, the bond of the company A may be labeled as a junk bond when the value of a “closing price volatility compared with the previous day” attribute of the bond of the company A exceeds a predetermined level and thus the volatility is determined to be high. Accordingly, the processor 110 may cause the third artificial neural network 620 to evaluate stability of a bond as collateral by considering the closing price volatility of the bond in addition to the rating of the bond. With respect to new input data (i.e., third attribute group data) about a company’s bond, the trained third artificial neural network 620 may output, as a risk value, a probability that the company’s bond is a junk bond.

The processor 110 may input data 610 about the third attribute group into the third artificial neural network 620, and may determine, based on the output of the third artificial neural network 620, the third risk value 630 indicating the degree of risk of the company’s bond. The processor 110 may determine a final risk value of the company’s stock as collateral based on the first risk value and the third risk value. The process in which the processor 110 determines the final risk value based on the first risk value and the third risk value may be performed by assigning a weight to each risk value, similarly to the process of determining the final risk value based on the first risk value and the second risk value.

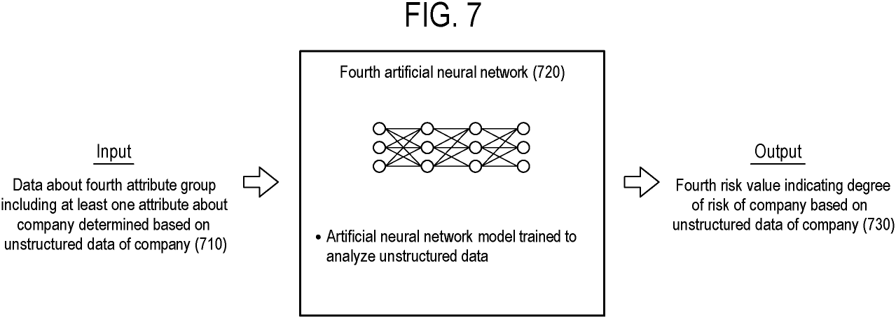

FIG. 7 is a conceptual diagram illustrating a process in which the computing device 100 according to an embodiment of the present disclosure determines a fourth risk value 730 based on an output of a fourth artificial neural network 720. In an embodiment, the memory 120 may store the fourth artificial neural network 720 trained to analyze unstructured data. The processor 110 may determine, through the fourth artificial neural network 720, the fourth risk value 730 indicating a degree of risk of a company based on various types of unstructured data about the company. In the present disclosure, the company’s unstructured data may include, for example, notes to the company’s financial statement, news data about the company, and social network service (SNS) data about the company. The notes to a financial statement refers to data that is difficult to express quantitatively in financial statement, and may be text data that includes, for example, phrases such as “transactions between specially related parties,” “whether there is a guarantee by a specially related party,” “transactions between related-subsidiary companies,” “other provisional guarantee liabilities,” and “long-term inventory” in the financial statement. The news data and/or the social network service (SNS) data about companies may include articles written by media outlets, articles written on portal sites, etc.

Specifically, the processor 110 may determine, based on unstructured data of the company, data 710 about a fourth attribute group including at least one attribute about a company. In the present disclosure, the data about the fourth attribute group may be referred to as “fourth attribute group data” for convenience. The fourth attribute group data may include at least one word embedding vector. In order to determine the data 710 about the fourth attribute group based on the company’s unstructured data, the processor 110 may preprocess the company’s unstructured data to generate multiple tokens, and may determine a word embedding vector corresponding to each token, based on a word embedding method. The word embedding method will be described later in detail.

The processor 110 according to an embodiment of the present disclosure may generate the multiple tokens from the unstructured data of the company by performing a morpheme analysis operation or a tokenizing operation with respect to the unstructured data of the company.

The processor 110 may classify a word or a phrase included in the company’s unstructured data into morpheme units through the morpheme analysis operation. The processor 110 may classify a word or a phrase included in the unstructured data into a substantial morpheme and a formal morpheme. The processor 110 may classify a word or a phrase included in the unstructured data into a lexical morpheme and a grammatical morpheme. The processor 110 may tag each word or phrase with the morpheme analysis result. Specifically, when the processor 110 performs a morpheme analysis operation on the text “I went home,” the text may be analyzed as “I/pronoun + went/verb + home/adverb.” In another example, when the processor 110 performs a morphological analysis operation on the text “a mountain is green,” the text may be analyzed as “a/article + mountain/noun + green/adjective.”

The processor 110 may perform a tokenizing operation of extracting multiple tokens from the unstructured data of the company. The tokenizing operation may be performed after the morpheme analysis operation described above. The processor 110 may extract, as a token, a word or phrase classified as a “substantive morpheme” or a “lexical morpheme” from the result of morpheme analysis on the unstructured data. The processor 110 may extract, as a token, a prototype of a word or phrase classified as a “substantial morpheme” or a “lexical morpheme” from the morpheme analysis result. For example, when two morphemes “home” and “go” in specific text are analyzed as substantial morphemes, the processor 110 may extract “home” and “go” as tokens, respectively. The description of the morpheme analysis operation or tokenizing operation for the aforementioned unstructured data of the company is only an example for explanation, and the present disclosure includes, without limitation, various methods for extracting multiple tokens by preprocessing unstructured data of a company.

The processor 110 may extract multiple tokens from the unstructured data of the company and then determine a word embedding vector corresponding to each token by using a word embedding method. In the present disclosure, “word embedding” may be a term referring to a method for expressing a word or phrase as a vector. In the present disclosure, the “word embedding vector” may be a term referring to a vector corresponding to a word or phrase according to the word embedding method. The word embedding vector may be a word vector according to sparse representation. The word vector according to the sparse representation may be, for example, a one-hot vector generated through one-hot encoding. In the one-hot vector, the index value of a word to be represented is 1, and the other index values may be represented as 0. The word embedding vector may be a word vector according to dense representation. The word vector according to the dense representation may be generated from a one-hot vector, for example, according to an algorithm such

as Continuous Bag Of Word (CBOW) or Skip-Gram. In the sparse representation, most values of elements of a vector or matrix are represented as 0. On the other hand, in the dense representation method, elements of a vector or matrix may have real values. In the present specification, it is assumed that the word embedding vector is a word vector according to dense representation. The word embedding method according to the present disclosure may include word2vec, FastText, Glove, etc. As described above, in the present disclosure, the fourth attribute group data about the company may include a word embedding vector corresponding to each of the multiple tokens which the processor 110 generates by preprocessing the unstructured data of the company.

In an embodiment of the present disclosure, the processor 110 may input the data 710 about the fourth attribute group into the fourth artificial neural network 720, and may determine, based on an output of the fourth artificial neural network 720, the fourth risk value 730 indicating the degree of risk of the company based on the unstructured data of the company. The fourth artificial neural network 720 for processing unstructured data may be an artificial neural network for processing a sequence in which an order exists among input data. For example, the fourth artificial neural network 720 may be an artificial neural network model having a recurrent neural network (RNN) structure. The fourth artificial neural network 720 may be trained to sequentially receive input of multiple word embedding vectors having a predetermined order and output a degree of risk of the input.

In an embodiment of the present disclosure, the fourth artificial neural network 720 may include a 4-1 sub artificial neural network for emotion analysis on unstructured data and a 4-2 sub artificial neural network for category analysis on the unstructured data.

The processor 110 may input the fourth attribute group data into the 4-1 sub-artificial neural network, and may perform positive/negative determination on the input, based on an output value according to the input. For example, the 4-1 sub artificial neural network may output a probability value close to 1 when unstructured data of a specific company mainly includes positive expressions about the company. Conversely, the 4-1 sub-artificial neural network may output a probability value close to 0 when the unstructured data of a specific company mainly includes negative expressions about the company.

The processor 110 may input the fourth attribute group data to the 4-2 sub artificial neural network, and may perform category classification on the input, based on an output value according to the input. The processor 110 may use the 4-2 sub artificial neural network to classify the fourth attribute group data as one of multiple predetermined categories. Each of the multiple predetermined categories may correspond to a predetermined keyword set. Also, each category may correspond to a predetermined weight. For example, a first category may correspond to a keyword set including keywords such as “stop,” “audit scope,” “embezzlement,” and “review opinion.” Also, the first category may correspond to “2” as a weight. In another example, a second category may correspond to a keyword set including keywords such as “insolvency,” “corporate review committee,” “filing for bankruptcy,” and “corporate rehabilitation.” Also, the second category may correspond to “3” as a weight. The processor 110 may input the fourth attribute group data on the unstructured data of the company to the 4-2 sub-artificial neural network, and may derive a most similar category and similar probability through a category classification task. The most similar category may be determined based on a vector distance between a word embedding vector of a keyword included in a keyword set corresponding to each category and word embedding vectors included in the fourth attribute group data.

In an embodiment of the present disclosure, the processor 110 may determine the fourth risk value 730 by performing the weighted sum of an output value of the 4-1 sub artificial neural network and an output value of the 4-2 sub artificial neural network. For example, the processor 110 may determine the fourth risk value 730 by multiplying a category similarity probability according to the output value of the 4-2 sub artificial neural network by a weight corresponding to a corresponding category and then adding an output value of the 4-1 sub artificial neural network thereto. As described above, the fourth artificial neural network 720 of the present disclosure may include the 4-1 sub artificial neural network and the 4-2 sub artificial neural network. Therefore, the processor 110 may perform emotion analysis and category classification on unstructured data in parallel, and may determine the fourth risk value 730 in consideration of both the emotion analysis and the category classification.

According to various embodiments of the present disclosure, the computing device 100 determines multiple risk values based on multiple artificial neural network models or numerical models, and may determine a final risk value based on at least one of the multiple risk values.

Specifically, as described above with reference to FIG. 2, the processor 110 may determine the data 210 about the first attribute group including at least one attribute about the company’s financial statement, may input the data 210 about the first attribute group into the first artificial neural network 220 trained to analyze the financial statement, and may determine, based on an output of the first artificial neural network 220, the first risk value 230 indicating the degree of risk of the company’s financial status. As described above with reference to FIG. 5, the processor 110 may determine the data 510 related to the second attribute group including at least one attribute about stock price volatility of the company, may input the data 510 about the second attribute group into the second artificial neural network 520 trained to analyze stock trades, and may determine, based on the output of the second artificial neural network 520, the second risk value 530 indicating the degree of risk of stock price volatility of the company. As described above with reference to FIG. 6, the processor 110 may determine the data 610 about the third attribute group including at least one attribute about the company’s bond, may input the data 610 about the third attribute group into the third artificial neural network 620 trained to analyze the company’s issued bond, and may determine, based on the output of the third artificial neural network 620, the third risk value 630 indicating the degree of risk of the company’s bond. As described above with reference to FIG. 7, the processor 110 may determine the data 710 about the fourth attribute group including at least one attribute about the company, may input the data 710 about the fourth attribute group into the fourth artificial neural network 720 trained to analyze unstructured data, and may determine, based on the output of the fourth artificial neural network 720, the fourth risk value 730 indicating the degree of risk based on the unstructured data of the company. The structure, operation method, and learning method of each artificial neural network have been described in detail above, so redundant descriptions thereof will be omitted.

The processor 110 may determine a final risk value based on at least one of the first risk value 230, the second risk value 530, the third risk value 630, and the fourth risk value 730. Hereinafter, a description will be made of a process of determining the final risk value based on all of the first risk value 230, the second risk value 530, the third risk value 630, and the fourth risk value 730. The processor 110 may determine the final risk value by averaging the risk values determined based on the artificial neural networks (so-called soft voting method). The processor 110 may determine the final risk value by calculating a weighted average of the risk values determined based on the artificial neural networks (so-called weighted voting method). For example, the final risk value may be calculated as in Mathematical Expression 4 below.

$$\begin{matrix}F i n a l r i s k v a l u e \\ = \frac{f i r s t r i s k v a l u e ∗ f i r s t w e i g h t + s e c o n d r i s k v a l u e ∗ s e c o n d w e i g h t + ⋯ + N t h r i s k v a l u e ∗ N t h w e i g h t}{N}\end{matrix}$$

Here, a weight corresponding to each model, such as a first weight, a second weight, or the like, may be predetermined and stored in the memory 120. N in Mathematical Expression 4 is a factor representing the number of artificial neural networks, and may be a natural number.

According to an embodiment of the present disclosure, with respect to multiple companies, the processor 110 may determine a final risk value of each company’s stock according to the same method as Mathematical Expression 4 described above. The processor 110 may compare final risk values of the entire company with a predetermined threshold to determine lendable and non-lendable stocks. The processor 110 may determine, based on multiple predetermined interval thresholds, a loan grade according to a final risk value of a company.

According to an embodiment of the present disclosure, the processor 110 may use at least one risk value (i.e., at least one risk value among the first to fourth risk values), which functions as a basis for determining the final risk value, to determine whether there is at least one among a first risk of not recovering the principal and interest of a loan due to the occurrence of an event such as meeting criteria for administrative issue designation and delisting or meeting regulations on inclusion in and exclusion from administrative issues in the KOSDAQ market, a second risk of not recovering a part of the principal and interest of the loan due to the fall of a company’s stock price, and a third risk in terms of opportunity cost that may occur when not lending to the company.

In the present disclosure, the first risk may imply a risk caused when a loan was made based on determination that the loan was possible for a specific company, but it is impossible to recover the principal and interest of the loan due to the fact that the company meets the criteria for administrative issue designation and delisting, meets the regulations on inclusion in and exclusion from administrative issues in the KOSDAQ market, goes bankrupt, becomes subject to management, or goes into a rehabilitation procedure. The processor 110 may determine whether the first risk exists, based on the first risk value obtained from the first artificial neural network trained to analyze the company’s financial statement or the fourth risk value obtained from the fourth artificial neural network trained to analyze the company’s unstructured data. For example, when the first risk value or the fourth risk value is greater than or equal to each threshold, the processor 110 may determine that the first risk exists by determining that a negative event such as meeting criteria for administrative issue designation and delisting, meeting regulations on inclusion in and exclusion from administrative issues in the KOSDAQ market, bankruptcy, or management has occurred in the company.

In the present disclosure, the second risk may imply a risk caused when a loan was made based on determination that the loan was possible for a specific company, but it is impossible to recover a part of the principal and interest of the loan due to a sharp drop in the value of the company’s stock as collateral, thereby resulting in a loss greater than the collateral ratio. The processor 110 may determine whether the second risk exists, based on the second risk value obtained from the second artificial neural network trained to analyze the company’s stock trades or the third risk value obtained from the third artificial neural network trained to analyze a bond issued by the company. For example, when the second risk value or the third risk value is greater than or equal to each threshold, the processor 110 may determine that the second risk exists by determining that there is a possibility that the company’s stock may fall rapidly.

In the present disclosure, the third risk may imply a risk in terms of a potential loss related to an expected profit that was not obtained as a result of the fact that a loan was not made based on determination that the loan was not possible for a specific company, but it was later confirmed that the loan was possible. The processor 110 may determine whether the third risk exists based on the first to fourth risk values. For example, when a specific company is not currently able to get a loan and when the first to fourth risk values calculated for the company are all equal to or lower than respective thresholds, the processor 110 may determine that the third risk exists as a potential loss with respect to the company. That is, unlike the first risk or the second risk, when the third risk exists, the processor 110 may determine that a loan is possible for the company and may inform an operator of the determination by using a predetermined method.

According to various embodiments of the present disclosure, the computing device 100 may accurately measure the risk of a company’s stock as collateral, based on a financial statement that is directly disclosed by the company and enables checking of the business performance of the company. In other words, the computing device 100 according to the present disclosure may perform a fast and consistent valuation of a company’s stock based on the financial statement.

According to various embodiments of the present disclosure, the computing device 100 may calculate a final risk value in consideration of not only a company’s financial statement, but also stock trading information representing a change in the value of the company’s stock and information about a bond issued by the company, and thus may quantitatively calculate the risk of the company’s stock as collateral from various types of information.

According to various embodiments of the present disclosure, the computing device 100 calculates the final risk value in consideration of not only the company’s financial statement but also the company’s unstructured data, and thus may calculate a predetermined numerical value from the unstructured data (e.g., text data) that is not quantitatively expressed, and may calculate, based on the numerical value, the risk for corporate stocks as collateral more accurately.

According to various embodiments of the present disclosure, the computing device 100 determines, based on a rolling window technique, at least one attribute to be input into the first artificial neural network or the second artificial neural network, and thus may determine optimal input data for increasing the performance of the artificial neural network. As a result, the computing device 100 according to the present disclosure may derive a risk value of the company’s stock with high accuracy, based on the first artificial neural network or the second artificial neural network.

According to various embodiments of the present disclosure, the computing device 100 may acquire a company’s financial statement, the value of the company’s stock, the value of the company’s bond, and unstructured data about the company in real time, and even for companies previously determined as lendable issues, may use at least one risk value, which is the basis for determining the final risk value, to continuously monitor the case in which: i) it is impossible to recover the principal and interest of a loan due to the occurrence of an event such as criteria for administrative issue designation and delisting or regulations on inclusion in and exclusion from administrative issues in the KOSDAQ market; or ii) it is impossible to recover a part of the principal and interest of the loan due to a sharp drop in the value of the company’s stock as collateral. In addition, even for a company for which a loan was determined to be impossible to be obtained, if a risk value calculated for the company is stably low, the company may be determined to be a company capable of obtaining a loan, thereby minimizing a potential loss that may occur when the loan is not carried out.

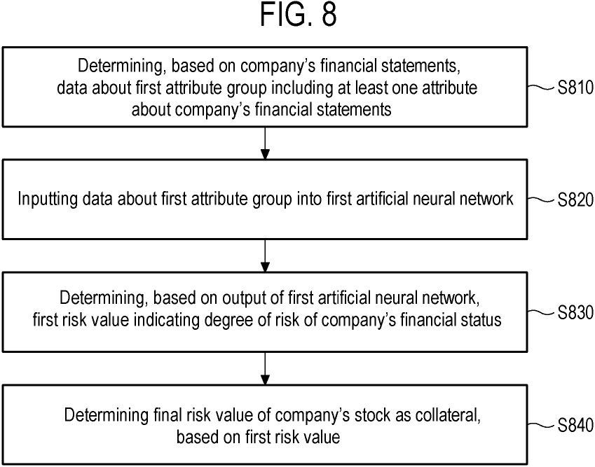

FIG. 8 is a flowchart of operations of a computing device according to an embodiment of the present disclosure. In operation S810, the computing device 100 according to an embodiment of the present disclosure may determine, based on a company’s financial statement, data about a first attribute group including at least one attribute about the company’s financial statement. The first attribute group may include each account title included in the financial statement as an attribute. For example, the first attribute group may include, as an attribute, at least one among cash, accounts receivable, commodities, land, buildings, patents, development costs, deposits, short-term borrowings, accounts payable, unearned revenue, debentures, capital, earned surplus reserve, stock options, etc. The data about the first attribute group may include raw data described in the financial statement. The data about the first attribute group may be a value derived according to a predetermined algorithm from a value of each attribute described in the financial statement.

In operation S820, the computing device 100 according to an embodiment of the present disclosure may input the data about the first attribute group into a first artificial neural network. The first artificial neural network may be trained based on a first learning data set including each piece of the first attribute group data labeled as whether the company’s financial status is risky or not. The first artificial neural network may be trained to classify each piece of learning data included in the first learning data set well.

In operation S830, the computing device 100 according to an embodiment of the present disclosure may determine, based on the output of the first artificial neural network, a first risk value indicating a degree of risk of the company’s financial status. The processor 110 may input, into the first artificial neural network, new input data having a similar form to individual learning data included in the first learning data set, and may predict a risk value (i.e., a first risk value) for the new input data, based on an output according to the input.

In operation S840, the computing device 100 according to an embodiment of the present disclosure may determine a final risk value of the company’s stock as collateral, based on the first risk value. The processor 110 may determine the final risk value by additionally reflecting a risk value derived based on another artificial neural network in the first risk value. The processor 110 may compare the determined final risk value with a predetermined threshold to finally determine whether a loan is possible or impossible for a specific company.

According to various embodiments of the present disclosure, it is possible to perform a fast and consistent valuation of a company’s stock, based on a financial statement.

According to various embodiments of the present disclosure, it is possible to calculate a predetermined numerical value from unstructured data (e.g., text data) that is not quantitatively expressed, and calculate, based on the numerical value, the risk of the company’s stock as an accurate collateral.

According to various embodiments of the present disclosure, it is possible to quantitatively calculate the risk of a company’s stock as collateral from various types of information such as a financial statement, stock information, bond information, and unstructured data.

According to various embodiments of the present disclosure, it is possible to determine optimal input data for increasing the performance of an artificial neural network model or a numerical model.

According to various embodiments of the present disclosure, it is possible to acquire a company’s financial statement, company stock volatility, the value of the company’s bond, and unstructured data about the company in real time, and even for companies previously determined as lendable issues, use at least one risk value, which is the basis for determining the final risk value, to continuously monitor the case in which: i) recovery of the principal and interest of a loan is impossible due to the occurrence of an event such as meeting criteria for administrative issue designation and delisting or meeting regulations on inclusion in and exclusion from administrative issues in the KOSDAQ market; or ii) recovery of the principal and interest of the loan is partially impossible due to a sharp drop in the value of the company’s stock as collateral. In addition, even for a company that was previously determined to be unable to get a loan, it is possible to determine the company as a company capable of getting the loan when a risk value calculated for the company is stably low, thereby minimizing a potential loss that may occur when the loan is not carried out.

In each flowchart illustrated in the present disclosure, the steps of the method or algorithm according to the present disclosure are described in a sequential order. However, in addition to being performed sequentially, the steps may be performed in an order in which the steps may be arbitrarily combined by the present disclosure. The description of the flowchart in the present disclosure does not exclude changes or modifications to the method or algorithm, and does not imply that a predetermined step is necessary or desirable. In an embodiment, at least some steps may be performed in parallel, repeatedly, or heuristically. In another embodiment, at least some steps may be omitted or another step may be added.

Various embodiments of the present disclosure may be implemented as software in a machine-readable storage medium. The software may be software for implementing the above-mentioned various embodiments of the present disclosure. The software may be inferred from various embodiments of the present disclosure by programmers in a technical field to which the present disclosure belongs. For example, the software may be a program including machine-readable instructions (e.g., code or code segments). A machine may be a device capable of operating according to an instruction called from the storage medium, and may be, for example, a computer. In an embodiment, the machine may be the computing device 100 according to embodiments of the present disclosure. In an embodiment, a processor of the machine may execute a called instruction to cause elements of the machine to perform a function corresponding to the instruction. In an embodiment, the processor may be the processor 310 according to embodiments of the present disclosure. The storage medium may imply any type of recording medium which stores machine-readable data. The storage medium may include, for example, ROM, RAM, CD-ROM, a magnetic tape, a floppy disk, an optical data storage device, and the like. In an embodiment, the storage medium may be the memory 320. In an embodiment, the storage medium may be implemented to be distributed to computer systems which are connected to each other through a network. The software may be distributed, stored, and executed in the computer systems. The storage medium may be a non-transitory storage medium. The non-transitory storage medium implies a tangible medium irrespective of whether data is stored semi-permanently or temporarily, and does not include a transitorily propagated signal.

Although the technical idea of the present disclosure has been described through various embodiments, the technical idea of the present disclosure includes various substitutions, modifications, and changes which may be made within the scope of the present disclosure that can be understood by those skilled in the art to which the present disclosure belongs. Furthermore, it should be understood that such substitutions, modifications, and changes may fall within the scope of the accompanying claims.

What is claimed is:

1. An apparatus, comprising:
at least one processor; and
at least one memory configured to store instructions, which cause the at least one processor to perform computation when executed by the at least one processor, a first artificial neural network trained to analyze a financial statement, and a fourth artificial neural network trained to analyze non-numerical unstructured data comprising notes to a financial statement,
wherein according to the instructions, the at least one processor is configured to:
verify at least one attribute relating to a financial statement of a company via a rolling window technique,
define, based on the verification, a first attribute group comprising at least a portion of the at least one attribute relating to the financial statement of the company,
determine, based on the financial statement of the company, data relating to the first attribute group,
input the data relating to the first attribute group into the first artificial neural network,
determine, based on an output of the first artificial neural network, a first risk value indicating a degree of risk of financial status of the company,
determine, based on non-numerical unstructured data of the company, data relating to a fourth attribute group comprising at least one attribute relating to the company,
input the data relating to the fourth attribute group into the fourth artificial neural network,
determine, based on an output of the fourth artificial neural network, a fourth risk value indicating a degree of risk of the company based on the non-numerical unstructured data of the company, and
determine a final risk value of stocks of the company as collateral, based on the first risk value and the fourth risk value.

2. The apparatus of claim 1, wherein the at least one attribute included in the first attribute group is an attribute which has a value derived based on raw data included in a period of a predetermined length, among a plurality of pieces of raw data included in the financial statement of the company.

3. The apparatus of claim 1, wherein the first artificial neural network is trained to, based on a learning data set comprising data relating to a plurality of first attribute groups and labeled as risky or not, classify each piece of learning data included in the learning data set.

4. The apparatus of claim 1, wherein the at least one memory is configured to further store a second artificial neural network trained to analyze stock trades, and
wherein the at least one processor is configured to:
determine, based on information relating to stock trades of the company, data relating to a second attribute group comprising at least one attribute relating to stock price volatility of the company,
input the data relating to the second attribute group into the second artificial neural network,
determine, based on an output of the second artificial neural network, a second risk value indicating a degree of risk of the stock price volatility of the company, and
determine the final risk value based on the first risk value, the second risk value, and the fourth risk value.

5. The apparatus of claim 4, wherein the at least one attribute included in the second attribute group is an attribute which has a value derived based on raw data included in a period of a predetermined length among a plurality of pieces of raw data relating to the stock trades of the company.

6. The apparatus of claim 2, wherein the at least one attribute determined based on the raw data included in the period of the predetermined length is determined based on a rolling window technique.

7. The apparatus of claim 5, wherein the at least one attribute determined based on the raw data included in the period of the predetermined length is determined based on a rolling window technique.

8. The apparatus of claim 4, wherein the second artificial neural network comprises at least one weight,
wherein the at least one processor is configured to determine the at least one weight based on a learning data set, which comprises data relating to a plurality of second attribute groups and labeled as risky or not, and an error back propagation algorithm related to the learning data set, and
wherein the at least one weight is determined such that an error calculated based on an output value of the second artificial neural network and a label value of the learning data set is minimized.

9. The apparatus of claim 1, wherein the at least one memory is configured to further store a third artificial neural network trained to analyze a corporate bond, and
wherein the at least one processor is configured to:
determine, based on information relating to a bond issued by the company, data relating to a third attribute group comprising at least one attribute relating to the bond of the company,
input the data relating to the third attribute group into the third artificial neural network,
determine, based on an output of the third artificial neural network, a third risk value indicating a degree of risk of the bond of the company, and
determine the final risk value based on the first risk value, the third risk value, and the fourth risk value.

10. The apparatus of claim 9, wherein the third artificial neural network is trained to, in response to an input of the data relating to the third attribute group determined for each of bonds of different companies having an identical rating, determine the third risk value for each bond, based on volatility of closing prices of the bonds issued by the companies compared with that of a previous day.

11. The apparatus of claim 1, wherein the fourth artificial neural network comprises:
a (4-1)th sub artificial neural network for emotion analysis on the non-numerical unstructured data; and
a (4-2)th sub-artificial neural network for category analysis on the non-numerical unstructured data.

12. The apparatus of claim 11, wherein the at least one processor is configured to determine the fourth risk value by performing a weighted sum of an output value of the (4-1)th sub artificial neural network and an output value of the (4-2)th sub artificial neural network.

13. The apparatus of claim 1, wherein the at least one memory is configured to further store a second artificial neural network trained to analyze stock trades and a third artificial neural network trained to analyze a corporate bond, and
wherein the at least one processor is configured to:
determine, based on information relating to stock trades of the company, data relating to a second attribute group comprising at least one attribute relating to stock price volatility of the company,
input the data relating to the second attribute group into the second artificial neural network,
determine, based on an output of the second artificial neural network, a second risk value indicating a degree of risk of the stock price volatility of the company,
determine, based on information relating to a bond issued by the company, data relating to a third attribute group comprising at least one attribute relating to the bond of the company,
input the data relating to the third attribute group into the third artificial neural network,
determine, based on an output of the third artificial neural network, a third risk value indicating a degree of risk of the bond of the company, and
determine the final risk value based on the first risk value, the second risk value, the third risk value, and the fourth risk value.

14. A method performed in a computer comprising at least one processor and at least one memory configured to store instructions to be executed by the at least one processor,
wherein the at least one memory is configured to store the instructions, which cause the at least one processor to perform computation, a first artificial neural network trained to analyze a financial statement, and a fourth artificial neural network trained to analyze non-numerical unstructured data comprising notes to a financial statement,
the method being performed by the at least one processor according to the instructions and comprising:
verifying at least one attribute relating to a financial statement of a company via a rolling window technique,
defining, based on the verification, a first attribute group comprising at least a portion of the at least one attribute relating to the financial statement of the company,
determining, based on the financial statement of the company, data relating to the first attribute group;
inputting the data relating to the first attribute group into the first artificial neural network;
determining, based on an output of the first artificial neural network, a first risk value indicating a degree of risk of financial status of the company;
determining, based on non-numerical unstructured data of the company, data relating to a fourth attribute group comprising at least one attribute relating to the company,
inputting the data relating to the fourth attribute group into the fourth artificial neural network,
determine, based on an output of the fourth artificial neural network, a fourth risk value indicating a degree of risk of the company based on the non-numerical unstructured data of the company, and
determining a final risk value of stocks of the company as collateral, based on the first risk value and the fourth risk value.

15. The method of claim 14, wherein the at least one memory is configured to further store a second artificial neural network trained to analyze stock trades,
the method being performed by the at least one processor and further comprising:
determining, based on information relating to stock trades of the company, data relating to a second attribute group comprising at least one attribute relating to stock price volatility of the company;
inputting the data relating to the second attribute group into the second artificial neural network;
determining, based on an output of the second artificial neural network, a second risk value indicating a degree of risk of the stock price volatility of the company; and
determining the final risk value based on the first risk value, the second risk value, and the fourth risk value.

16. The method of claim 14, wherein the at least one memory is configured to further store a third artificial neural network trained to analyze a corporate bond,
the method being performed by the at least one processor and further comprising:
determining, based on information relating to a bond issued by the company, data relating to a third attribute group comprising at least one attribute relating to the bond of the company;
inputting the data relating to the third attribute group into the third artificial neural network;
determining, based on an output of the third artificial neural network, a third risk value relating to the bond of the company; and
determining the final risk value based on the first risk value, the third risk value, and the fourth risk value.

17. The method of claim 14, wherein the at least one memory is configured to further store a second artificial neural network trained to analyze stock trades and a third artificial neural network trained to analyze a corporate bond,
the method being performed by the at least one processor and further comprising:
determining, based on information relating to stock trades of the company, data relating to a second attribute group comprising at least one attribute relating to stock price volatility of the company;
inputting the data relating to the second attribute group into the second artificial neural network;
determining, based on an output of the second artificial neural network, a second risk value indicating a degree of risk of the stock price volatility of the company;
determining, based on information relating to a bond issued by the company, data relating to a third attribute group comprising at least one attribute relating to the bond of the company;
inputting the data relating to the third attribute group into the third artificial neural network;
determining, based on an output of the third artificial neural network, a third risk value relating to the bond of the company; and
determining the final risk value based on the first risk value, the second risk value, the third risk value, and the fourth risk value.

18. A non-transitory computer-readable recording medium storing instructions to be executed in a computer, wherein at least one memory is configured to store the instructions, which cause at least one processor to perform computation, a first artificial neural network trained to analyze a financial statement, and a fourth artificial neural network trained to analyze non-numerical unstructured data comprising notes to a financial statement,
wherein the instructions, when executed by the at least one processor, cause the at least one processor to:
verify at least one attribute relating to a financial statement of a company via a rolling window technique,
define, based on the verification, a first attribute group comprising at least a portion of the at least one attribute relating to the financial statement of the company,
determine, based on the financial statement of the company, data relating to the first attribute group,
input the data relating to the first attribute group into the first artificial neural network,
determine, based on an output of the first artificial neural network, a first risk value indicating a degree of risk of financial status of the company,
determine, based on non-numerical unstructured data of the company, data relating to a fourth attribute group comprising at least one attribute relating to the company,
input the data relating to the fourth attribute group into the fourth artificial neural network,
determine, based on an output of the fourth artificial neural network, a fourth risk value indicating a degree of risk of the company based on the non-numerical unstructured data of the company, and
determine a final risk value of stocks of the company as collateral, based on the first risk value and the fourth risk value.
